(19) United States
(12) Patent Application Publication
(10) Pub. No.: US 2024/0093057 A1
(43) Pub. Date: Mar. 21, 2024

(54) MULTI-CURE POLYMER SYSTEMS FOR ADDITIVE MANUFACTURING

(71) Applicant: OPT Industries, Inc., Medford, MA (US)

(72) Inventor: James Shin, Sharon, MA (US)

(73) Assignee: OPT Industries, Inc., Medford, MA (US)

(21) Appl. No.: 18/271,108

(22) PCT Filed: Jan. 6, 2022
(86) PCT No.: PCT/US2022/011412

§ 371 Date: Jul. 6, 2023

Related U.S. Application Data
(60) Provisional application No. 63/135,019, filed on Jan. 8, 2021.

(51) Int. Cl. C09D 175/14; B29C 64/245; B29C 64/264; B33Y 30/00; B33Y 70/00; C08G 18/10; C08G 18/64; C08G 18/80; C08G 18/81

(52) U.S. Cl. CPC C09D 175/14; B29C 64/245; B29C 64/264; B33Y 30/00; B33Y 70/00; C08G 18/10; C08G 18/6423; C08G 18/8093; C08G 18/8125; B29C 64/135

(57) ABSTRACT

Provided herein are systems and methods for forming a polymeric object. The systems and methods can use monomers having a first type of functional group that is capable of polymerizing upon exposure to radiation and a second type of functional group that is capable of polymerizing at a second condition. The monomers can be polymerized such that the polymeric object has a first and a second network of linkages.

### CROSS-REFERENCE TO RELATED APPLICATIONS

This application claims the benefit of priority under 35 U.S.C. 119(e) of U.S. provisional patent application No. 63/135,019, titled “MULTI-CURE POLYMER SYSTEMS FOR ADDITIVE MANUFACTURING”, filed on Jan. 8, 2021, which is incorporated by reference herein in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Additive manufacturing technology, also known as 3D printing, allows for the manufacture of finished products with complex geometries that are difficult or impossible to make with other technologies. High-resolution stereolithography 3D printing, specifically Digital Light Processing (DLP) printing technology, can allow printing resolutions of less than 100 micrometers (um). High-resolution 3D printing allows one to produce intricate structures to reduce object weight, construct metamaterials, realize biomimicry design or simply achieve aesthetic surface textures.

### SUMMARY

Although the resolution of recent 3D printers has been improving, some applications can be limited by inadequate properties of the polymeric object being printed using prior methods. Without limitation, the systems and methods described herein can print polymeric objects that are strong without being brittle. This can be achieved by using monomers that have at least two different functional groups and curing mechanisms that polymerize under different conditions. Radiation (i.e., UV light) can be used in the 3D printing process to produce a “green” article that has a first network of polymer linkages (e.g., by a radical polymerization process). A second polymerization process can (e.g., initiated by heat) can then cure the “green” article to create a second network of polymer linkages that are in covalent communication with the first network of polymer linkages. As used herein, “covalent communication” means that the first and second network of polymer linkages are effectively a single network of linkages, i.e., that are connected through a common network of covalent bonds. This is in contrast to two polymer networks that are simply entangled and not chemically connected through a common network of covalent bonds.

The systems and methods described herein address some of the major technical problems associated with DLP-based 3D printing. First, some embodiments allow formulations with even lower viscosity compared to prior formulations (e.g., which can have some high molecular weight viscous oligomers. Second, some embodiments also reduce or eliminate the need to incorporate diluents (i.e., due to lower formulation viscosity) which reduce the viscosity but adversely affect the mechanical properties of the printed article. Third, some embodiments allow the use of dual-cure chemistry to impart toughness, elasticity and flexibility to 3D articles in addition to high modulus. This is in contrast to previous methods that utilize an interpenetrating polymer network strategy.

Furthermore, monomers with functional group types greater than two can result in a covalently crosslinked network. Covalently crosslinked networks used in the additive manufacturing industry with acrylates only are typically considered to be brittle due to the lack of high elongation potential and the inadequate properties from the acrylates. However, the dual-cure chemistry described herein can enable stresses to be more efficiently transferred due to the presence of the covalent crosslinks from the high modulus, low elongation vinyl polymer backbone, to the moderate modulus, high elongation polyurethane/polyurea polymer segments which contains soft polymer moieties with these desirable properties, allowing for a material with balanced and more desirable properties from both chemistries and functional groups.

In an aspect, provided herein is a method for forming a polymeric object. The method can include providing a solution comprising one or more monomers. The monomers can have a first type of functional group that is capable of polymerizing upon exposure to radiation at a first condition and a second type of functional group which is capable of polymerizing under a second condition that is different than the first condition. The method can further include using radiation to initiate a first polymerization reaction at a first location of the solution that is adjacent to a substrate, whereby the first type of functional groups at the first location polymerize to form a solid comprising a network of first covalent linkages. The method can further include using additional radiation to initiate a second polymerization reaction at a second location of the solution that is adjacent to the first location, whereby the first functional groups at the second location polymerize to grow the network of first linkages and increase a volume of the solid. The method can further include removing the solid from the solution and initiating a third polymerization reaction which forms second linkages between the second functional groups in the solid, thereby forming a polymeric object having a network of the first linkages in covalent communication with the second linkages.

In some embodiments, the solution includes a photo-initiator.

In some embodiments, the photo-initiator causes free-radical polymerization of the first functional groups at the first condition.

In some embodiments, the first linkages are vinyl linkages.

In some embodiments, the first functional group is an unsaturated group.

In some embodiments, the first functional group is an acrylate group, a methacrylate group, vinyl ester group, a vinyl carbonate group, an anhydride group or any combination thereof.

In some embodiments, the solution comprises a monomer having at least two copies of the first functional group.

In some embodiments, the first functional group on a first molecule of the monomer forms a covalent bond with a first functional group on a second molecule of the monomer during the first and second polymerization reactions.

In some embodiments, the solution comprises a monomer having only one copy of the first functional group.

In some embodiments, the first functional group on a first molecule of the monomer forms a covalent bond with an unsaturated group on a second molecule of the monomer during the first and second polymerization reactions.

In some embodiments, the third polymerization reaction is initiated using heat or moisture.

In some embodiments, the third polymerization is initiated by heating to a temperature of at least about 100° C.

In some embodiments, the second linkages are urethane or urea linkages after curing

In some embodiments, the second functional group is an isocyanate group.

In some embodiments, the isocyanate groups in the solution are blocked before the third polymerization

In some embodiments, the isocyanate groups are blocked with diethyl malonate or methyl ethyl ketoxime.

In some embodiments, the isocyanate groups are unblocked prior to or during the third polymerization.

In some embodiments, the solution comprises a first type of monomer having at least two isocyanate groups and a second type of monomer having at least two hydroxyl or amine groups.

In some embodiments, the isocyanate groups on a first type of monomer react with hydroxyl or amine groups on the second type of monomer to form the second linkages.

In some embodiments, the monomer is diisocyanato-acrylic monomer (DIAM).
In some embodiments, the DIAM monomer has a polyester backbone, a polyether backbone, a polyvinyl backbone, a silicone backbone, or an epoxide backbone.
In some embodiments, the solution comprises a single type of monomer.

In some embodiments, the single type of monomer has at least one isocyanate group and at least one unsaturated group.

In some embodiments, the single type of monomer has at least two isocyanate groups.

In some embodiments, the single type of monomer has at least two unsaturated groups.

In some embodiments, the solution comprises a first type of monomer and a second type of monomer.

In some embodiments, the first type of monomer has at least two isocyanate groups and at least one unsaturated group.

In some embodiments, the second type of monomer is a chain extender having at least two amines or hydroxyls, which amines or hydroxyls are capable of reacting with the isocyanate groups on the first type of monomer.

In some embodiments, the substrate is moved relative to the solution between the initiation of the first polymerization and the second polymerization.

In some embodiments, solution is washed from the solid prior to initiation of the third polymerization.

In some embodiments, the solid is washed with isopropyl alcohol, propylene carbonate, tripropylene glycol, monomethyl ether, and combinations thereof.

In some embodiments, the photo-initiator is a Type-I photo-initiator such as Diphenyl(2,4,6-trimethylbenzoyl) phosphine oxide (TPO) which cleaves to form free radical fragments upon exposure to radiation.

In some embodiments, the photo-initiator is a Type-II photo-initiator such as benzophenone or isopropyl thioxanthone which uses radiation to achieve an excited state then proceeds to abstract a hydrogen from a synergist (typically amine based, such as a tertiary amine) to form a radical on the synergist which is used for polymerization.

In some embodiments, the solution does not initially have oligomers of the one or more monomers.

In some embodiments, the solution further comprises oligomers of the one or more monomers.

In some embodiments, the solution further comprises a diluent.

In some embodiments, the diluent reacts with the monomer during the first and second polymerization.

In some embodiments, the solution further comprises one or more pigments, dyes, UV absorbers, hindered amine light stabilizers, and fillers.

In some embodiments, the solution has a low viscosity.

In another aspect, described herein is a system for forming a polymeric object. The system can include a volume of a solution comprising one or more monomers having a first functional group that is capable of polymerizing upon exposure to radiation at a first condition and a second functional group which is capable of polymerizing under a second condition that is different than the first condition. The system can include a pliable substrate configured to be moved through the solution. The system can include a radiation source configured to direct radiation at a chosen location of the solution at the first condition, whereby the first functional groups at the chosen location polymerize to form a solid article on the pliable substrate, which solid article comprises a network of first linkages. The system can include a secondary cure module configured to subject the solid article to the second condition, thereby initiating polymerization of the second functional groups to form second linkages, thereby forming a polymeric object having a network of the first linkages in covalent communication with the second linkages.

In some embodiments, the pliable substrate is a vinyl mesh.

In some embodiments, the solid article is removed from the volume of solution prior to introducing the solid article to the secondary cure module.

In some embodiments, the system further comprises a wash module configured to wash the solid article of solution prior to introducing the solid article to the secondary cure module.

In some embodiments, the radiation source is a digital micromirror device (DMD).

In some embodiments, the volume of solution is kept at a constant level relative to the radiation source.

In some embodiments, the secondary cure module comprises a heater or cooler.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF FIGURES

FIG. 1 shows an example of a diisocyanato-acrylic monomer (DIAM).

FIG. 2 shows an example of reversable blocking of DIAM isocyanate groups.

FIG. 3 shows an example of photopolymerization of a DIAM network.

FIG. 4 shows an example of thermal curing of a DIAM network.

FIG. 5 shows an example of synthesis of DIAM pre-polymer.

FIG. 6 shows an example of a 3D printing system that utilizes a pliable substrate.

### DESCRIPTION

Additive manufacturing technology, also known as 3D printing, is a manufacturing method that utilizes the instrument to manufacture finished “additive” products with complex geometries that can be difficult or impossible to make with other conventional manufacturing methods such as molding (inject and transfer molding, etc.) and subtractive manufacturing (laser cutting and milling, etc.). Additive manufacturing methods can have extensive advantages over conventional methods. First, it allows for manufacture parts with highly intricate shapes and internal lattice structures. Second, it generates little waste and has high starting material utilization, especially in comparison with subtractive manufacturing such as milling. Third, it enables fast production with little lead time and low tooling cost. This can be especially true compared to molding methods which need to make molds before the desired parts are fabricated using the molds. Fourth, it enables on-demand fabrication of parts in small quantities without having to prepare expensive molds beforehand. It can also allow easy modification based on the fabricated part evaluation and is highly useful for prototyping. Overall, additive manufacturing methods can have extensive advantages over conventional manufacturing practices in many aspects.

Additive manufacturing methods can be categorized based on the materials or by technology used. Material selection for printing, includes, but is not limited to, thermoplastic and thermoset polymers, photopolymers (photo-monomers/oligomers to be exact), metals, ceramics, (hydro)gels, paste, sand, composites, etc. Common 3D printing methods include fused deposition modeling (FDM, also known as fused filament fabrication (FFF)), digital light processing (DLP), stereolithography (SLA), selective laser sintering (SLS), directed energy deposition (DED), direct ink writing (DIW), and binder jetting (BJ). FDM/FFF, SLS, and SLA/DLP are by far the most popular and the three main printing techniques that are in constant research and development worldwide.

Materials for the additive manufacturing can utilize a multitude of polymerization techniques to create 3D articles with desirable material performance properties for end-use applications.

### Polymer Systems for DLP-Based 3D Printing

DLP and SLA are 3D printing techniques suitable for performing the systems and methods described herein. SLA and DLP 3D printers can vary regarding how light is projected onto the UV curable polymer resins. Earlier printers generally use SLA based on a laser system that moves around to cure the targeted area pixel by pixel. DLP, however, can cure a whole layer at one time. DLP 3D printers can use a digital projector screen to flash an image of a layer across the entire platform, curing all points in the same layer simultaneously. The light can be reflected on a Digital Micromirror Device (DMD), which is a dynamic mask comprising microscopic-size mirrors laid out in a matrix on a semiconductor chip. Rapidly toggling these tiny mirrors between the lens(es) that direct the light towards the resin can define the coordinates where the liquid resin cures within the given layer. Because the projector is a digital screen, the image of each layer is composed of square pixels, resulting in a three-dimensional layer formed from small rectangular cubes called voxels. This can enable DLP to become one of the fastest 3D printing techniques. Its other advantages include, but are not limited to, relatively low cost, versatile printing polymer selection, high printing resolution, and ease of operation.

DLP can have a selection of polymers and composites to print from including acrylates and methacrylate-functional polymers. UV curable formulations used in the DLP additive manufacturing industry can include ethylenically and/or vinyl-functional (i.e., double bond) oligomers and monomers (e.g., acrylates, methacrylates, vinyl ethers, vinyl carbonates), diluents, chain extenders, photo-initiators, and additives. The oligomers and monomers can provide mechanical properties to the final product upon polymerization. Diluents are used to reduce overall formulation viscosity for ease of processing and handling. Diluents can be reactive and can be incorporated into the polymer matrix of the finished article. Photo-initiators can form free radicals upon exposure to actinic radiation (e.g., through photolytic degradation of the photo-initiator molecule). The free radicals can then initiate and propagate with the vinyl moieties of the oligomers and monomers to form vinyl-based, crosslinked polymers. Additives can include but are not limited to pigments, dyes, UV absorbers, hindered amine light stabilizers, and fillers. Additives can be used to impart useful properties such as color, shelf stability, improved lifetime performance, higher UV stability, etc.

Acrylates have the advantages of being abrasion-resistant, strong, and stiff, but they can be brittle. DLP printing uses UV lights to cure the polymer resins via radical mechanisms, where the reaction takes place at these “double-bond” locations and links them together. Additional functionality can be introduced to the side chains of acrylates. As described herein, urethane chemistry can be introduced to improve the mechanical properties. Urethane-based polymers can be tailored to have a wide range of mechanical properties, due to possessing a hard and soft segment. These segmented block copolymers can be tuned by changing the polyol (soft segment) and diol length and type. One can also utilize urethane/urea chemistry and linkage as shown below (e.g., for faster curing). In addition, (meth)acrylate functional groups can also be introduced, such as additional silicone segments. As such, more desirable properties such as strength, modulus, elongation, thermal, and chemical properties can be enhanced.

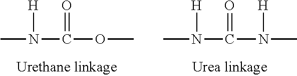

In some urethane acrylate and methacrylate 3D printing resins, the urethanes are relatively chemically inert and no longer react with other functional groups or moieties either by radiation such as UV light and electron beam (EB) or by heat. The chemical compositions after curing are only covalently linked through the acrylate backbones. Since the other desirable properties provided by functional groups such as urethanes and silicones are on the side chains, the overall property improvements are not so dramatic in some cases. Therefore, provided herein are 3D-printable resins that can have dual or multiple curing mechanisms and functionalities so that double-network or multi-crosslinked resins with different linkages beyond acrylates are achieved.

### Dual Cure Chemistry

In some cases, dual-cure chemistries which utilize more than one type of polymerization process can be employed in the production of 3D articles in the additive manufacturing industry. The term “dual-cure” can refer to the use of two different chemistries and curing methods to obtain desirable material properties in the finished article. One chemistry referred to as the “first chemistry” utilizes actinic radiation to generate a polymer network as used in traditional 3D printing methods. Another chemistry, referred to as the “second chemistry” can utilize an initiator or other agents other than actinic radiation to initiate the polymerization process (e.g., heat or moisture).

As described herein, the first chemistry comprises components that polymerize upon exposure to actinic radiation, e.g., through the use of a photo-initiator which generates free radicals which further react with ethylenically unsaturated functional groups, such as (meth)acrylate or vinyl ester groups. The free radical can proceed to propagate until radicals either terminate or have no more functional groups available for chain growth. This chemistry serves to create the 3D article's shape through the spatially selective application of actinic radiation to a photopolymerizable liquid.

The second chemistry can comprise components that polymerize through a non-radical based mechanism, such as a step-growth polymerization process. In some cases, polyurethane or polyurea-based chemistries can be used as the second chemistry to obtain the final desired mechanical properties. This chemistry can utilize isocyanates, polyols, and/or polyamines, and chain extenders to generate polyurethanes or polyureas through the application of heat to drive polymerization within the previously formed vinyl-based network. A 3-dimensional (3D) article with desired shape and desired materials performance can be generated using the dual-cure chemistry described herein.

Prior dual-cure chemistries pertaining to the production of 3D articles in the additive manufacturing industry generally refers to the formation of interpenetrating polymer networks, referred to as IPNs, where the vinyl polymers formed from the first chemistry have no physical connection to the polyurethane or polyurea polymers formed from the second chemistry (i.e., are not in covalent communication). As described herein, a 3D article produced using dual-cure chemistries that are not in covalent communication derives less synergistic benefit from the interaction of the two co-existing networks (other than through physical entanglement).

In some embodiments, described herein is a dual-cure chemistry that utilizes a monomer with both an isocyanate functionality (e.g., of at least 2), and an ethylenically unsaturated functionality (e.g., acrylate, methacrylate or vinyl; of at least 1). In some cases, the monomer has at least 2 unsaturated groups.

### Use of DIAM Monomer

The diisocyanato-acrylic monomer, referred to herein as DIAM, can offer several advantages when used in dual-cure formulations for the additive manufacturing industry. The DIAM's isocyanate groups can be reacted with blocking agents. In some cases, the blocking agents have no additional reactive functionality beyond the moiety that reacts with the isocyanate. This can prevent premature polymerization with chain extender species in the monomer solution and also to prevent reaction with ambient moisture.

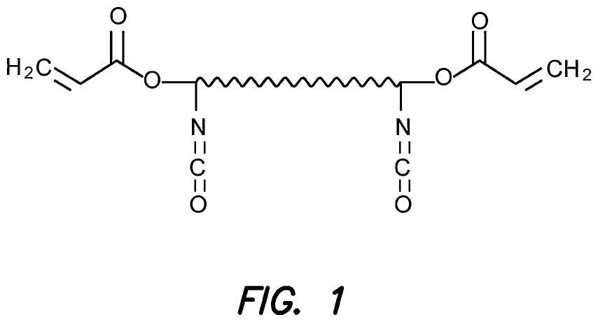

FIG. 1 shows an example of a DIAM monomer. The ethylenically unsaturated groups are acrylates, the backbone represented by the wavy line comprises an aliphatic polyester backbone, and the two isocyanate groups are featured as pendant to the backbone.

Depending on the choice of chain extender, polyol, polyamine and/or polycarboxylic acid, different backbone chemistries for the secondary polymer network can be realized, including but not limited to, polyesters, polyethers, polyvinyls, silicones, and epoxies.

The DIAM monomer can be capped at either one or both ends by an ethylenically unsaturated group, typically an acrylate, methacrylate, or vinyl ether group, and can feature pendant isocyanate groups (e.g., at least two) along its backbone.

The isocyanate groups can also be reversibly blocked, e.g., to prevent reaction of these groups prior to printing of the solid article and/or forming the second linkages in a second cure step.

A formulation that utilizes DIAM, used in the context of additive manufacturing, allows for the formation of a crosslinked polymer network featuring vinyl and polyurethane/polyurea polymer backbones, possibly through the use of DIAM which provides pendant isocyanate groups for the step growth polymerization of polyurethane/polyurea polymer chains. A formulation utilizing DIAM also enables formulations, useful in the production of 3D articles. The DIAM-based dual-cure chemistry described herein can form the polyurethane or polyurea polymers from the second chemistry to be covalently bonded to the vinyl network formed from the first chemistry. In addition, the amount of the secondary functional groups can be tuned, thus the crosslinking density can be varied, which can further determine the mechanical and thermal properties of the final printed, dual-cured products.

Furthermore, the use of a low molecular weight DIAM can reduce hydrogen bonding arising from the urethane bonds in the blocked DIAM variant, which in turn reduces formulation viscosity. For example, diethyl malonate, a widely-used blocking agent for the urethane bonds, is generally regarded as safe and commonly used in beverages and cosmetics. It offers excellent protection of urethane bonds and easy removal for further crosslinking to achieve the dual cure effect.

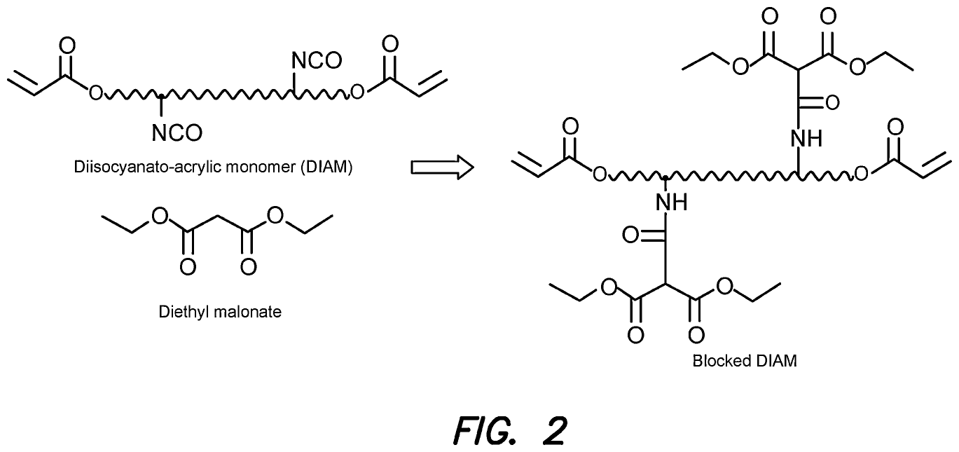

As shown in FIG. 2, DIAM can be reacted with a blocking agent such as diethyl malonate, optionally with a catalyst under an inert, water-free environment. Reaction can take place at elevated temperature from 50-100 C, or 80-100 C. Diethyl malonate, or another blocking agent, can be added dropwise to the reaction flask containing DIAM. Flask contents can be mechanically stirred to promote dispersion. The diisocyanate groups can be unblocked and polymerized using heat (e.g., at a temperature of 100-120 C).

The DIAM can form a crosslinked network through polymerization of the unsaturated groups (“first network”) upon exposure to actinic radiation, e.g., through the generation of free radicals from photo-initiator cleavage. Once the 3D article has been formed through the creation of the first network, the 3D article can be subjected to another initiating event (e.g., applied heat). The heat can cause the unreactive blocking agent to detach from the isocyanate, regenerating the reactive isocyanate group. The regenerated isocyanate groups can further react with chain extenders to generate a singular crosslinked network comprising both vinyl and polyurethane or polyurea polymer backbones in a 3-dimensional, double-network covalent communication (as opposed to IPN-based approaches).

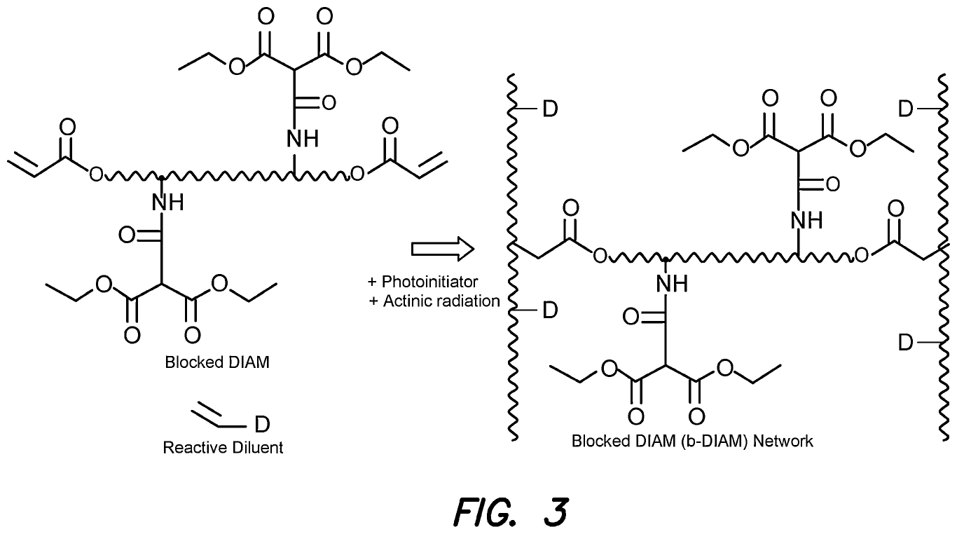

As shown in FIG. 3, the first network can be formed upon photo-initiated polymerization of unsaturated groups (e.g., using ultraviolet (UV) radiation to create a free radical from a photo-initiator molecule). As shown here, the unsaturated groups can react with any suitable group, e.g., at appending functional groups or suitable sites along the DIAM backbone.

Blocked DIAM, referred to as b-DIAM, can also react with diluents upon exposure of actinic radiation through the generation of free radicals from photo-initiator cleavage. The reaction product is a cross-linked “green” polymer network, which also comprises b-DIAM crosslinks. In some embodiments, the solution does not have a diluent. The methods provided herein can reduce the need for diluent because lower molecular weight monomers can be used for 3D printing rather than higher molecular weight oligomers. The use of oligomers can increase the viscosity of the solution, which can be offset with the use of diluents. In some cases, the diluent is reactive with the monomer(s) in order to produce an article that does not have residual organic liquids which are not bound to the solid article.

This first polymeric network can provide a solid article with suitable structural and mechanical stability to be removed from the monomer solution and rinsed off residual monomers. The 3D article thus formed may be washed with solvent at this point to remove any excess resin coating the surface. Potential compatible solvents include isopropyl alcohol and propylene carbonate. At which point, the solid article can be subjected to a second cure operation to form the desired polymeric object that is stronger and tougher and less brittle.

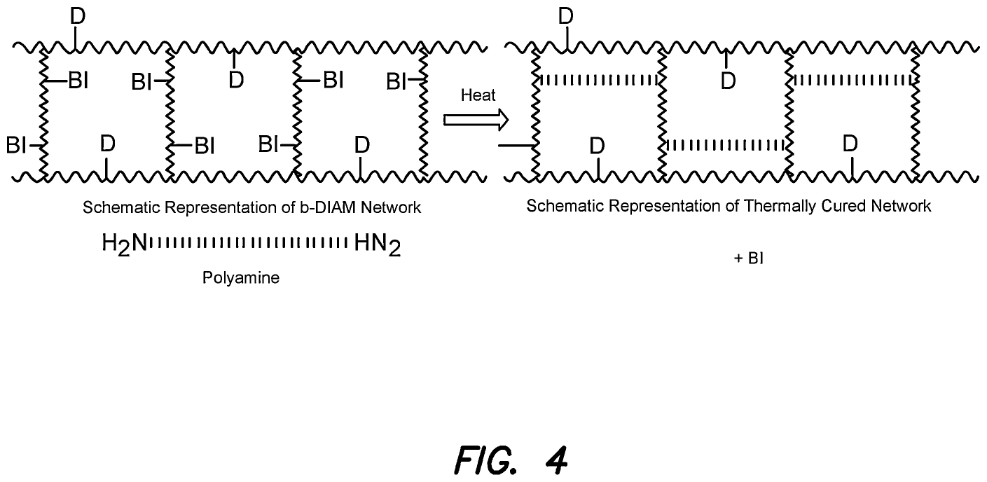

As shown in FIG. 4, the b-DIAM network can be reacted with chain extenders upon application of heat. In some instances, the chain extenders are a second type of monomer that, along with DIAM, produce a co-polymer. In this figure, polyamine backbone is represented by vertical dashed lines, the vinyl network is represented by wavy lines, and the DIAM backbone is represented by zig-zag lines. Blocked isocyanate (BI) and reactive diluent (D) are also shown.

The UV-cured b-DIAM network, upon the application of heat, can regenerate diethyl malonate and the reactive isocyanate groups. The reactive isocyanate groups can then react with chain extenders present in the formulation to create the second polymer network composed of either urethane bonds (if the chain extender is a diol) or urea bonds (if the chain extender is a diamine). Optionally an organometallic catalyst may be included to increase the reaction rate of isocyanate and alcohol addition (e.g., catalyst can be bismuth-based, tin-based, etc.). In some embodiments, the isocyanate and chain extender reaction take place from 100-140 C. For example, the reaction can take place at 100-120 C for 2-10 hours (e.g., 4-8 hours). After thermal treatment, the 3D article is cooled to room temperature and can be ready for application use.

The method described herein can form a crosslinked double network featuring covalently bonded vinyl and polyurethane/polyurea backbones without the use of high molecular weight oligomers. Such high molecular weight oligomers can result in high viscosity formulations which can have several disadvantages (e.g., increasing the time needed for the solution to reflow after a layer of printing). As a result of the lower formulation viscosity and thus reduced need for reactive diluents, it is possible to now incorporate a larger percentage of polyurethane/polyurea polymers which endows enhanced toughness and flexibility depending on the hard and soft segment in them, leading to a final 3D-printed article with enhanced mechanical and thermal properties suitable for end-use applications.

The methods described herein can use a monomer with ethylenically unsaturated groups along with pendant isocyanate groups that are blocked from further reaction until the application of heat. This monomer (DIAM) can be included in formulations suitable for additive manufacturing, which may include the following components: oligomers, monomers, diluents, chain extenders, photo-initiators, pigments, dyes, catalysts, UV absorbers, hindered amine light stabilizers, and fillers. An example of a monomer solution suitable for 3D printing using dual-cure chemistry can include 0.5-2% photo-initiator, 0.01-1% UV additives, 20-50% blocked DIAM, chain extenders in stoichiometric balance with DIAM isocyanates, with the remainder diluents.

The underlying DIAM structure can be modified or varied. Features of the DIAM that can be modified include backbone chemistry (e.g., polyester based), backbone length, number of pendant isocyanate/ethylenically unsaturated groups, length of pendant isocyanate backbone, or chain chemistry of pendant isocyanate group. The chain extenders can also be modified or varied. Features that can be modified include backbone chemistry, functionality of reactive groups, and type of reactive group (e.g., amine, alcohol, epoxy, silicon-hydride).

In some cases, the methods and systems described herein can use a polymerizable liquid, comprising a mixture of an unreactive blocked monomer of Structure 1

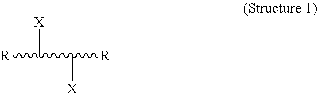

where R is a reactive epoxy, alkene, alkyne, or thiol group; where the backbone of Structure 1, represented by the wavy bond, is polyester or polyether; where X is an independently selected substituent of Structure 2

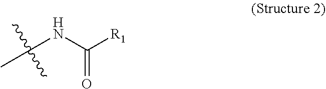

where R₁ is an unreactive blocking group.

Note that several features of the DIAM can be modified. For example, the length of the side chains bearing the isocyanate moiety can be modified (e.g., to increase the rate of the curing process, potentially at the expense of increased viscosity of the printing solution).

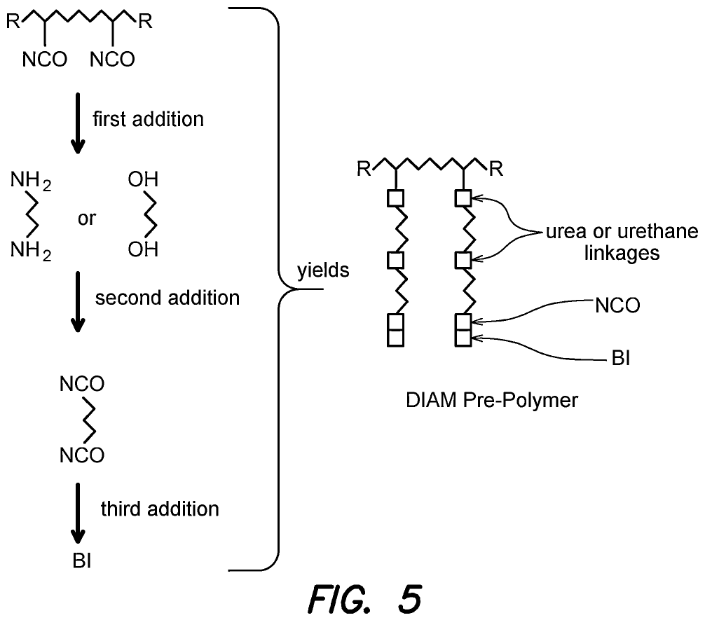

As shown in FIG. 5, a DIAM pre-polymer can be created by starting with DIAM, reacting a polyol or polyamine to the NCO groups, then reacting a diisocyanate to the attached polyol or polyamine. Finally, the isocyanate can be capped with a blocking agent (BI). This DIAM pre-polymer can be used in the systems and methods described herein.

### Printing Systems

Also, it should be appreciated that one or more 3D printing systems may be used to implement the methods described herein. These can include a proprietary or commercially available 3D printer (e.g., a DLP printer). The printer can direct UV radiation through a transparent window to contact the photo-curable resin described herein.

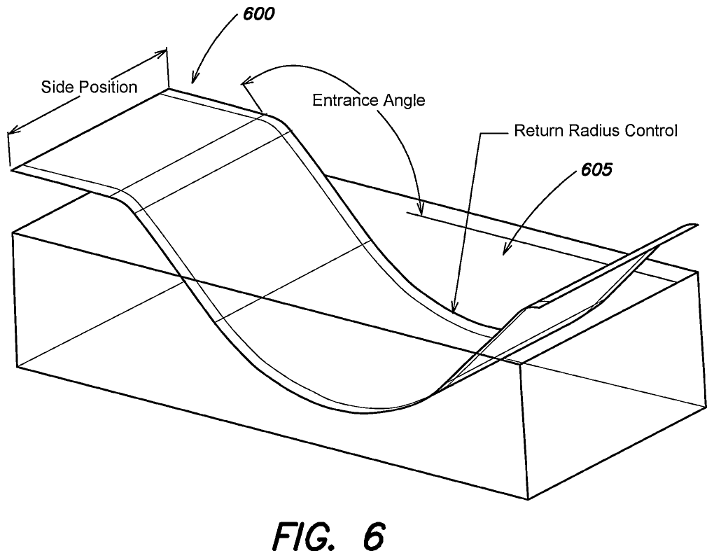

In some cases, the UV radiation can be directed to an exposed surface of a volume of resin (i.e., printed top-down). FIG. 6 shows an example of a system where a pliable substrate 600 is moved through a vat of resin 605. UV radiation can be directed at the resin in proximity to where the sheet enters the resin, where the sheet is at a consistent angle (e.g., about 45°) with respect to the resin surface. The sheet can be moved forward following printing of a layer of the article, at which point additional resin can flow over the printed area (i.e., recoating), allowing printing of another layer. The process can be repeated to form the printed article. The printed article can be washed of non-cured resin and subjected to a second (e.g., thermal) curing step as described herein. For example, some embodiments may be used in conjunction with one or more systems described in U.S. patent application Ser. No. 16/552,382, filed Aug. 27, 2019, incorporated herein in its entirety. However, it should be appreciated that other printer methods and systems may be used with embodiments as described herein.

The geometry of the article to be printed can be digitally represented in any suitable file structure (e.g., for use in controlling the 3D printer). Such systems can include slicing the geometry into a plurality of layers, e.g., as described in U.S. patent application Ser. No. 17/211,603, filed Mar. 24, 2021, incorporated herein in its entirety. Such systems, methods, and file formats can be suitable for printing microstructures.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of some embodiments comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of some embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the at least some of the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A method for forming a polymeric object, comprising:
a. providing a solution comprising one or more monomers having (i) a first type of functional group that is capable of polymerizing upon exposure to radiation at a first condition and (ii) a second type of functional group which is capable of polymerizing under a second condition that is different than the first condition;
b. using radiation to initiate a first polymerization reaction at a first location of the solution that is adjacent to a substrate, whereby the first type of the functional groups at the first location polymerize to form a solid comprising a network of first linkages;
c. using radiation to initiate a second polymerization reaction at a second location of the solution that is adjacent to the first location, whereby the first functional groups at the second location polymerize to grow the network of first linkages and increase a volume of the solid;
d. removing the solid from the solution; and
e. initiating a third polymerization reaction which forms second type of linkages between the second type of functional groups in the solid, thereby forming a polymeric object having a network of the first linkages in covalent communication with the second linkages.

2. The method of claim 1, wherein the solution includes a photo-initiator.

3. (canceled)

4. The method of claim 1, wherein the first linkages are vinyl linkages.

5. The method of claim 1, wherein the first functional group is an unsaturated group.

6. The method of claim 1, wherein the first functional group is an acrylate group, a methacrylate group, a vinylester group, a vinylcarbonate group, an anhydride group or any combination thereof.

7. The method of claim 1, wherein the solution comprises a monomer having at least two copies of the first functional group.

8. The method of claim 1, wherein the first functional group on a first molecule of the monomer forms a covalent bond with a first functional group on a second molecule of the monomer during the first and second polymerization reactions.

9. The method of claim 1, wherein the solution comprises a monomer having only one copy of the first functional group.

10. The method of claim 1, wherein the first functional group on a first molecule of the monomer forms a covalent bond with an unsaturated group on a second molecule of the monomer during the first and second polymerization reactions.

11. The method of claim 1, wherein the third polymerization reaction is initiated using heat or moisture.

12. (canceled)

13. The method of claim 1, wherein the second linkages are urethane or urea linkages.

14. The method of claim 1, wherein the second functional group is an isocyanate group.

15. The method of claim 1, wherein the isocyanate groups in the solution are blocked.

16. The method of claim 1, wherein the isocyanate groups are blocked with diethyl malonate or methyl ethyl ketoxime.

17. The method of claim 15, wherein the isocyanate groups are unblocked prior to or during the third polymerization.

18-21. (canceled)

22. The method of claim 1, wherein the solution comprises a single type of monomer.

23. The method of claim 22, wherein the single type of monomer has at least one isocyanate group and at least one unsaturated group.

24. The method of claim 23, wherein the single type of monomer has at least two isocyanate groups.

25. (canceled)

26. The method of claim 1, wherein the solution comprises a first type of monomer and a second type of monomer.

27-39. (canceled)

40. A system for forming a polymeric object, comprising
a. a volume of a solution comprising one or more monomers having (i) a first functional group that is capable of polymerizing upon exposure to radiation at a first condition and (ii) a second functional group which is capable of polymerizing under a second condition that is different than the first condition;
b. a pliable substrate configured to be moved through the solution;
c. a radiation source configured to direct radiation at a chosen location of the solution at the first condition, whereby the first functional groups at the chosen location polymerize to form a solid article on the pliable substrate, which solid article comprises a network of first linkages; and
d. a secondary cure module configured to subject the solid article to the second condition, thereby initiating polymerization of the second functional groups to form second linkages, thereby forming a polymeric object having a network of the first linkages in covalent communication with the second linkages.

41-46. (canceled)
